(19) United States
(12) Patent Application Publication
(10) Pub. No.: US 2008/0292882 A1
(43) Pub. Date: Nov. 27, 2008

(54) SYNTHETIC QUARTZ GLASS WITH FAST AXES OF BIREFRINGENCE DISTRIBUTED IN CONCENTRIC-CIRCLE TANGENT DIRECTIONS AND PROCESS FOR PRODUCING THE SAME

(75) Inventors: Noriyuki AGATA, Chiyoda-ku (JP); Masaaki TAKATA, Chiyoda-ku (JP); Tomonori OGAWA, Chiyoda-ku (JP); Kei IWATA, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Chiyoda-ku (JP)

(21) Appl. No.: 12/182,361

(22) Filed: Jul. 30, 2008

Related U.S. Application Data
(63) Continuation of application No. PCT/JP07/51875, filed on Jan. 30, 2007.

(30) Foreign Application Priority Data
Jan. 30, 2006 (JP) 2006-020920

(51) Int. Cl. C03C 12/00; C03B 37/005

(52) U.S. Cl. 428/402; 65/426

(57) ABSTRACT

The present invention provides a synthetic quartz glass having a diameter of 100 mm or more for using in an optical apparatus comprising a light source emitting a light having a wavelength of 250 nm or less, the synthetic quartz glass having, in a region located inward from the periphery thereof by 10 mm or more in a plane perpendicular to the optical axis of the synthetic quartz glass: a birefringence of 0.5 nm or less per thickness of 1 cm with respect to a light having a wavelength of 193 nm; an OH group concentration of 60 ppm or less; an averaged differential OH group concentration from the center of the synthetic quartz glass toward a peripheral direction thereof, normalized with respect to the radius of the synthetic quartz glass, of −8 to +60 ppm; and an unbiased standard deviation a of a differential OH group concentration from the center of the synthetic quartz glass toward a peripheral direction thereof, normalized with respect to the radius of the synthetic quartz glass, of 10 ppm or less, the unbiased standard deviation a being determined with the following formula (1):

$$σ = \sqrt{\frac{{\sum }_{i = 1}^{n} {( {X}_{i} - \overline{X} )}^{2}}{n - 1}} \\ providing ; \\ {X}_{i} = \frac{Δ {\overline{n}}_{OH i}}{Δ {r}_{i}^{*}} = \frac{{\overline{n}}_{OH i} - {\overline{n}}_{OH i + 1}}{ {r}_{i}^{*} - {r}_{i + 1}^{*}} \qquad ( 1 )$$

: differential OH group concentration at measurement point i normalized with respect to the radius R of the synthetic quartz glass;

$${\overline{n}}_{OH i} = \frac{{n}_{OH i - 1} + {n}_{OH i} + {n}_{OH i + 1}}{3}$$

: OH group concentration at measurement point i in terms of moving average for three points including the two points before and after the measurement point i;

$${r}_{i}^{*} = \frac{{r}_{i}}{R}$$

: radius at measurement point i normarized with respect to the radius R of the synthetic quartz glass;
   X̅
: average of OH group concentrations Xi in the whole evaluation region; and
   n
: number of measurement points in the evaluation region (integer of 2 or more).

### FIELD OF THE INVENTION

The present invention relates to a synthetic quartz glass which has fast axes of birefringence distributed in concentric-circle tangent directions and is for use as optical elements of an exposure apparatus employing a short-wavelength exposure light source, such as a KrF excimer laser (wavelength, 248 nm), ArF excimer laser (wavelength, 193 nm), or F₂ excimer laser (wavelength, 157 nm). The invention further relates to a process for producing the quartz glass.

### BACKGROUND ART

Photolithographic techniques have been used for the formation of fine circuit patterns in producing semiconductor devices, and exposure apparatus are widely utilized. With the recent trends toward higher density, higher operating speeds, and lower power consumption in integrated circuits, the scale down of integrated circuits progresses considerably. Consequently, exposure apparatus are required to attain high resolution while maintaining a large focal depth.

In order to obtain high resolution, exposure light sources having shorter wavelengths are being employed. Recently, KrF excimer lasers (wavelength, 248 nm) and ArF excimer lasers (wavelength, 193 nm) have come to be used as exposure light sources in place of the g-line (wavelength, 436 nm) and i-line (wavelength, 365 nm) heretofore in use. The technique of obtaining high resolution by using a projection lens having an increased numerical aperture is also progressing. With the increase in lens diameter, the technique of immersion exposure using pure water or a high-refractive-index liquid has come to be applied. (See, for example, Reference 1.)
[Reference 1] Soichi Owa, “Immersion Lithography”, Oyo Butsuri, Vol. 74, No. 9, pp. 1192-1195 (2005)

### DISCLOSURE OF THE INVENTION

### Problems to be Resolved by the Invention

Birefringent properties are one of the properties required of optical elements for use in exposure apparatus in the microprocessing of semiconductors. Birefringent properties impair the imaging characteristics of an optical system. Birefringent properties mean that property of a material by which it has different refractive indexes depending on the direction of light polarization. In general, this property is observed in crystalline material having optical anisotropy. In amorphous material such as synthetic quartz glasses, birefringent properties are induced by a stress present in the synthetic quartz glasses. Quantitatively, the difference between the maximum value and minimum value of refractive index on a given optical axis which are attributable to polarization directions is defined as birefringence. Birefringence represents the absolute value of birefringent properties. A direction axis parallel to the direction of polarization in which refractive index is minimum is defined as a fast axis, which means that the phase of light waves in that polarization direction is transmitted most rapidly. The fast axis indicates the direction of birefringent properties. Conversely, a direction axis parallel to the direction of polarization in which refractive index is maximum is called a slow axis. Incidentally, since the birefringent properties of an amorphous material are attributable to a stress present in the material, the directions of the fast axis and slow axis depend on the directions of the principal axes of stress. In general, the stress field for a synthetic quartz glass to be used as an optical element can be assumed to be a plane stress field with respect to a plane perpendicular to the optical axis. In this case, the principal axes of stress are perpendicular to each other and, hence, the fast axis and the slow axis are perpendicular to each other.

As a result of the recent scale down of semiconductor devices, the adverse influence of birefringent properties on imaging characteristics has become not negligible. Consequently, the desire for a reduction of the birefringence of synthetic quartz glasses is becoming severer year by year. Furthermore, since the optical system of each exposure apparatus employs optical elements made of two or more synthetic quartz glasses and optical elements, the birefringence relating to the property of actually forming an image on a wafer corresponds to the value obtained by integrating the birefringent effects of all optical elements crossing the optical axis extending from the light source to the wafer (hereinafter, this birefringence is referred to as “accumulated birefringence”). Consequently, for reducing this accumulated birefringence, the individual synthetic quartz glasses included in the same optical system should have lower values of birefringence. The synthetic quartz glasses are required to be reduced in birefringence even to a level which is extremely difficult to attain in view of the nature of the production thereof.

It is generally known that for reducing the birefringence of a synthetic quartz glass to be used as an optical element, it is preferred to relieve the residual stress in the synthetic quartz glass, and that it is effective to conduct an appropriate annealing treatment for stress relief. Examples of this appropriate annealing treatment include a method in which the synthetic quartz glass is held at a high temperature for a sufficiently long time period in order to relieve the residual stress in the glass and is then cooled at a sufficiently low rate in order to prevent the generation of a new residual stress during the cooling (in the invention, such annealing conducted for the purpose of residual stress relief is hereinafter referred to as “precision annealing”). By sufficiently reducing the rate of cooling in the precision annealing treatment, a synthetic quartz glass having a low birefringence can be produced. This method, however, has drawbacks, for example, that productivity decreases considerably because the precision annealing treatment necessitates much time and that contamination with impurities coming from the treatment environment is apt to occur.

On the other hand, a method is known in which the accumulated birefringence mentioned above is reduced by suitably combining the fast-axis directions of optical elements constituting the same optical system. This method is explained below with respect to an optical system comprising two synthetic quartz glasses as an example. In the case where the two synthetic quartz glasses, A and B, have the same magnitude of birefringence and have such distributions that the fast-axis directions for one glass are perpendicular to those for the other, the birefringent effects of the two synthetic quartz glasses countervail each other because the directions of the fast axes of synthetic quartz glass A are the same as those of the slow axes of synthetic quartz glass B. As a result, the accumulated birefringence is zero.

Consequently, for reducing the accumulated birefringence of an optical system comprising two or more optical elements, it is effective to regulate the directions of the fast axes besides reducing the magnitude of birefringence of each of the synthetic quartz glasses constituting the optical system. In particular, since the desire for a reduction of the birefringence of each synthetic quartz glass is coming to reach a level which is extremely difficult to attain in view of the nature of the production thereof, that method of accumulated birefringence reduction by regulating fast axes is expected to become increasingly important in future.

However, a production process for regulating the directions of the fast axes of a synthetic quartz glass has not been sufficiently established, and it has been difficult to produce a synthetic quartz glass having a given distribution.

### Means of Solving the Problems

An object of the invention is to regulate the directions of the fast axes of a synthetic quartz glass and provide a synthetic quartz glass having a given distribution of fast-axis directions in order to overcome the problems described above.

The present inventors made close investigations on factors which may influence the fast-axis distribution of a synthetic quartz glass for use as an optical element. As a result, they have found that the distribution of the concentration of OH groups contained in a synthetic quartz glass is a factor which influences the fast-axis distribution and that a desired distribution of fast-axis directions is obtained by regulating the distribution of OH group concentration.

The first aspect of the invention provides a synthetic quartz glass having a diameter of 100 mm or more for using in an optical apparatus comprising a light source emitting a light having a wavelength of 250 nm or less, the synthetic quartz glass having, in a region located inward from the periphery thereof by 10 mm or more in a plane perpendicular to the optical axis of the synthetic quartz glass: a birefringence of 0.5 nm or less per thickness of 1 cm with respect to a light having a wavelength of 193 nm; an OH group concentration of 60 ppm or less; an averaged differential OH group concentration from the center of the synthetic quartz glass toward a peripheral direction thereof, normalized with respect to the radius of the synthetic quartz glass, of −8 to +60 ppm; and an unbiased standard deviation a of a differential OH group concentration from the center of the synthetic quartz glass toward a peripheral direction thereof, normalized with respect to the radius of the synthetic quartz glass, of 10 ppm or less,

the unbiased standard deviation σ being determined with the following formula (1):

$$σ = \sqrt{\frac{{\sum }_{i = 1}^{n} {( {X}_{i} - \overline{X} )}^{2}}{n - 1}} \\ providing ; \\ {X}_{i} = \frac{Δ {\overline{n}}_{OH i}}{Δ {r}_{i}^{*}} = \frac{{\overline{n}}_{OH i} - {\overline{n}}_{OH i + 1}}{ {r}_{i}^{*} - {r}_{i + 1}^{*}} \qquad ( 1 )$$

: differential OH group concentration at measurement point i normalized with respect to the radius R of the synthetic quartz glass;

$${\overline{n}}_{OH i} = \frac{{n}_{OH i - 1} + {n}_{OH i} + {n}_{OH i + 1}}{3}$$

: OH group concentration at measurement point i in terms of moving average for three points including the two points before and after the measurement point i;

$${r}_{i}^{*} = \frac{{r}_{i}}{R}$$

: radius at measurement point i normarized with respect to the radius R of the synthetic quartz glass;

X̅
: average of OH group concentrations Xi in the whole evaluation region; and

n
: number of measurement points in the evaluation region (integer of 2 or more).

The second aspect of the invention provides a synthetic quartz glass having a diameter of 100 mm or more for using in an optical apparatus comprising a light source emitting a light having a wavelength of 250 nm or less, the synthetic quartz glass having, in a region extending from the center of the synthetic quartz glass to 90% of the radius thereof in a plane perpendicular to the optical axis of the synthetic quartz glass: a birefringence of 0.5 nm or less per thickness of 1 cm with respect to a light having a wavelength of 193 nm; an OH group concentration of 100 ppm or less; the difference, obtained by subtracting: the OH group concentration at the center of the synthetic quartz glass; from the OH group concentration at the position of 90% of the radius from the center of the synthetic quartz glass, of −8 to +60 ppm; and an unbiased standard deviation σ of a differential OH group concentration from the center of the synthetic quartz glass toward a peripheral direction thereof, normalized with respect to the radius of the synthetic quartz glass, of 10 ppm or less, the unbiased standard deviation σ being determined with the following formula (2):

$$σ = \sqrt{\frac{{\sum }_{i = 1}^{n} {( {X}_{i} - \overline{X} )}^{2}}{n - 1}} \\ providing ; \\ {X}_{i} = \frac{Δ {\overline{n}}_{OH i}}{Δ {r}_{i}^{*}} = \frac{{\overline{n}}_{OH i} - {\overline{n}}_{OH i + 1}}{ {r}_{i}^{*} - {r}_{i + 1}^{*}} \qquad ( 2 )$$

: differential OH group concentration at measurement point i normalized with respect to the radius R of the synthetic quartz glass;

$${\overline{n}}_{OH i} = \frac{{n}_{OH i - 1} + {n}_{OH i} + {n}_{OH i + 1}}{3}$$

: OH group concentration at measurement point i in terms of moving average for three points including the two points before and after the measurement point i;

$${r}_{i}^{*} = \frac{{r}_{i}}{R}$$

: radius at measurement point i normarized with respect to the radius R of the synthetic quartz glass;

X̅
: average of OH group concentrations Xi in the whole evaluation region; and

n
: number of measurement points in the evaluation region (integer of 2 or more).

The third aspect of the invention provides a process for producing a synthetic quartz glass, comprising dehydrating a porous glass body having a bulk density of 0.10 to 0.90 g/cm³ at a temperature of 1100 to 1350° C. for 60 hours or more under at least one of: a reduced pressure; and an atmosphere having a low partial pressure of water vapor.

The synthetic quartz glasses according to the first and second aspects of the invention each are obtained by regulating the distribution of OH group concentration and are a synthetic quartz glass in which the fast axes are distributed in the directions of tangents to concentric circles.

### ADVANTAGEOUS EFFECTS OF THE INVENTION

Since the synthetic quartz glasses provided by the invention have fast axes distributed in the directions of concentric-circle tangents, they are suitable for use as an optical element of an exposure apparatus employing a short-wavelength exposure light source, such as a KrF excimer laser (wavelength, 248 nm), ArF excimer laser (wavelength, 193 nm), or F₂ excimer laser (wavelength, 157 nm), when used in combination with an optical element comprising a synthetic quartz glass having fast-axis directions distributed radially.

### BRIEF DESCRIPTION OF THE DRAWINGS

FIG. 1 is a diagrammatic view showing the position of a birefringence evaluation point and the direction of a fast axis in a synthetic quartz glass.

FIG. 2 shows an example of the OH group concentration distribution of a synthetic quartz glass obtained through dehydration conducted for a relatively short time period.

FIG. 3 shows an example of the OH group concentration distribution of a synthetic quartz glass obtained through dehydration conducted for a relatively long time period.

FIG. 4 shows the relationship between the average OH group concentration gradient from the center of a synthetic quartz glass toward a peripheral direction thereof and the average value of θ_{xy}.

FIG. 5 shows the relationship between the average value of θ_{xy} and the difference obtained by subtracting the OH group concentration at the center of a synthetic quartz glass from the OH group concentration at a position of 90% of the radius from the center of the synthetic quartz glass.

FIG. 6 is a diagrammatic view showing measurement points for determining the directions of birefringent fast axes in a measurement region.

### DESCRIPTION OF THE REFERENCE NUMERALS AND SIGNS

The reference numerals used in the drawings denote the followings, respectively.
O: position of center axis of synthetic quartz glass
P: birefringence evaluation point
F: fast axis at birefringence evaluation point P
D_{xy}: angle formed by fast axis F at birefringence evaluation point P and X-axis
R_{xy}: angle formed by X-axis and straight line extending from center of synthetic quartz glass toward birefringence evaluation point P
1: measurement plane for determining fast-axis directions
2: measurement region for determining fast-axis directions in measurement plane 1
3: measurement point for determining fast-axis direction in measurement plane 1
4: line passing through center of measurement plane 1

### BEST MODE FOR CARRYING OUT THE INVENTION

Embodiments of the invention will be explained below by reference to examples thereof, but the invention should not be construed as being limited by the following explanation and examples in any way.

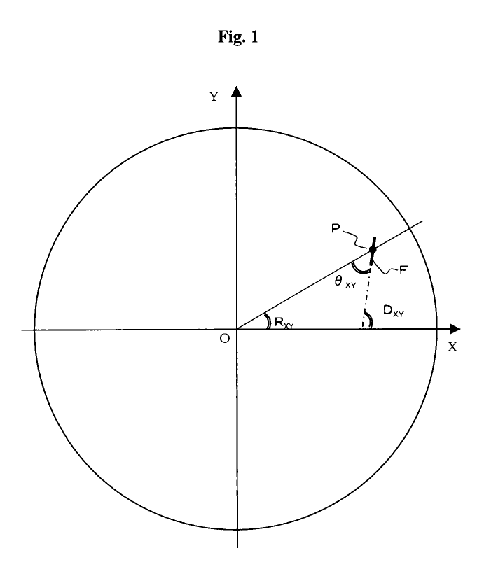

The definition of the direction of a fast axis in the synthetic quartz glasses of the invention is explained below. FIG. 1 is a diagrammatic view geometrically showing the position of a birefringence evaluation point and the direction of a fast axis in a plane perpendicular to the optical axis in a circular synthetic glass. In FIG. 1, O indicates the position of the center axis of the synthetic quartz glass. This point is taken as the origin in the coordinate system shown in FIG. 1. A coordinate axis passing through the origin O in any direction is taken as the X-axis, and the coordinate axis passing through the origin O and perpendicular to the X-axis is taken as the Y-axis. Symbol P indicates an arbitrary birefringence evaluation point in the synthetic quartz glass; F indicates the fast axis at the birefringence evaluation point P; R_{xy} represents the angle formed by the X-axis and a straight line connecting the origin O to the birefringence evaluation point P; and D_{xy} represents the angle formed by the fast axis F at the birefringence evaluation point P and the X-axis.

When the absolute value of the difference between the angle (R_{xy}) formed by the X-axis and the straight line extending from the center of the synthetic quartz glass toward the arbitrary birefringence evaluation point P and the direction of the fast axis F (D_{xy}) at the birefringence evaluation point P is 90° or smaller, then θ_{xy} is defined by the following equation (A). On the other hand, when the absolute value of the difference between the angle (R_{xy}) formed by the X-axis and the straight line extending from the center of the synthetic quartz glass toward the birefringence evaluation point P and the direction of the fast axis F (D_{xy}) at the birefringence evaluation point P exceeds 90°, then θ_{xy} is defined by the following equation (B).

When |R_{xy}−D_{xy}|≦90°: θ_{xy}=|R_{xy}−D_{xy}| (A)

When |R_{xy}−D_{xy}|>90°: θ_{xy}=180−|R_{xy}−D_{xy}| (B)

According to this definition of θ_{xy}, the fast axis at an arbitrary birefringence evaluation point P where the value of θ_{xy} is 0° is in a complete radial direction, while the fast axis at an arbitrary birefringence evaluation point P where the value of θ_{xy} is 90° is in a complete concentric-circle tangent direction. On the other hand, the cases where θ_{xy} is any of angles intermediate between them, i.e., θ_{xy} is a value larger than 0° and smaller than 90°, are categorized in the following manner in the invention. When the value of θ_{xy} at an arbitrary birefringence evaluation point P is smaller than 45°, the direction of this fast axis is defined as a radial direction. When the value of θ_{xy} is 45° or larger, the direction of this fast axis is defined as a concentric-circle tangent direction. Incidentally, the case where θ_{xy} is 45° is regarded as under the category of concentric-circle tangent directions.

In the invention, a synthetic quartz glass having fast axes distributed in the directions of tangents to concentric circles is obtained by regulating the distribution of OH group concentration in the synthetic quartz glass.

In a process for producing the synthetic quartz glasses of the invention, examples of the parts relating to the regulation of the distribution of OH group concentration include the following.

A gaseous raw material for forming fine glass particles is oxidized in a high-temperature atmosphere and the fine quartz glass particles obtained are deposited on a substrate to obtain a porous quartz glass body. Subsequently, the porous quartz glass body obtained is held in an atmosphere having a low partial water vapor pressure or at a reduced pressure, at a temperature slightly lower than temperatures at which a transparent glass is formed. Thus, the porous quartz glass body is dehydrated to reduce the concentration of OH groups. Thereafter, the porous quartz glass body is heated to a temperature at which the body is converted to a transparent glass. Thus, the porous quartz glass body is converted to a transparent quartz glass body. In this process, the distribution of OH group concentration in the synthetic quartz glass to be obtained through vitrification can be controlled by regulating the atmosphere, temperature, holding time, etc. in the dehydration step.

The raw material to be used for forming fine glass particles is not particularly limited as long as it can be gasified. However, silicon halide compounds such as chlorides, e.g., SiCl₄, SiHCl₃, SiH₂Cl₂, and Si(CH₃)Cl₃, fluorides, e.g., SiF₄ and SiH₂F₂, bromides, e.g., SiBr₄ and SiHBr₃, and iodides, e.g., SiI₄, are preferred, for example, because such compounds have a relatively high vapor pressure and are easy to gasify. Extremely preferred of them are the chlorides from the standpoints of raw material cost, easy availability of high-purity raw materials, etc. In general, any of those gaseous raw materials for forming fine glass particles is oxidized in an oxyhydrogen flame and the fine glass particles synthesized in the flame are to adhered to and deposited on a substrate to thereby form the porous quartz glass body.

In the invention, the method of dehydrating the porous quartz glass body thus obtained is conducted in a modified manner in order to obtain a synthetic quartz glass having fast axes distributed concentrically.

According to the dehydration treatment in the process, dehydration occurs from the surface of the porous quartz glass body whichever technique is used. Because of this, the OH group concentration in the transparent quartz glass body obtained through the dehydration treatment tends to be low in the quartz glass body surface and increase toward the center axis.

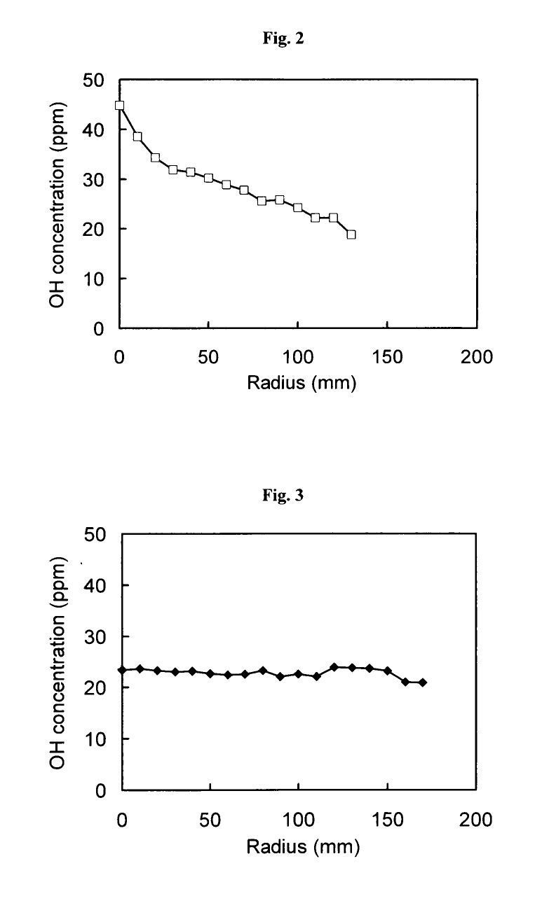

In the case where the time period of the dehydration treatment is relatively short, the OH groups in the surface of the porous quartz glass body are mainly desorbed, while the OH groups present about the center are apt to remain not-desorbed. Because of this, the transparent synthetic quartz glass tends to have an OH group concentration distribution in which the concentration is high about the center axis of the synthetic quartz glass and decreases toward the periphery. For example, the distribution is as shown in FIG. 2. FIG. 2 shows an example of the OH group concentration distribution of a synthetic quartz glass obtained through dehydration conducted for a relatively short time period; the abscissa is the distance from the center of the synthetic quartz glass and the ordinate is the concentration of OH groups.

On the other hand, in the case where the time period of the dehydration treatment is sufficiently long, the OH groups present about the center axis of the porous quartz glass are also desorbed. Because of this, the transparent synthetic quartz glass has a nearly even OH group concentration distribution. For example, the distribution is as shown in FIG. 3. FIG. 3 shows an example of the OH group concentration distribution of a synthetic quartz glass obtained through dehydration conducted for a relatively long time period; the abscissa is the distance from the center of the synthetic quartz glass and the ordinate is the concentration of OH groups.

The present inventors made intensive investigations on the relationship between the distribution of OH group concentration and the directions of fast axes. As a result, the following have been found. When a synthetic quartz glass has an OH group concentration distribution such as that shown in FIG. 2, the directions of the fast axes in most of this synthetic quartz glass are radial directions, i.e., the values of θ_{xy} in FIG. 1 are smaller than 45°. On the other hand, when a synthetic quartz glass has an OH group concentration distribution such as that shown in FIG. 3, there is a high tendency that the directions of the fast axes are tangent directions, i.e., the values of θ_{xy} are 45° or larger.

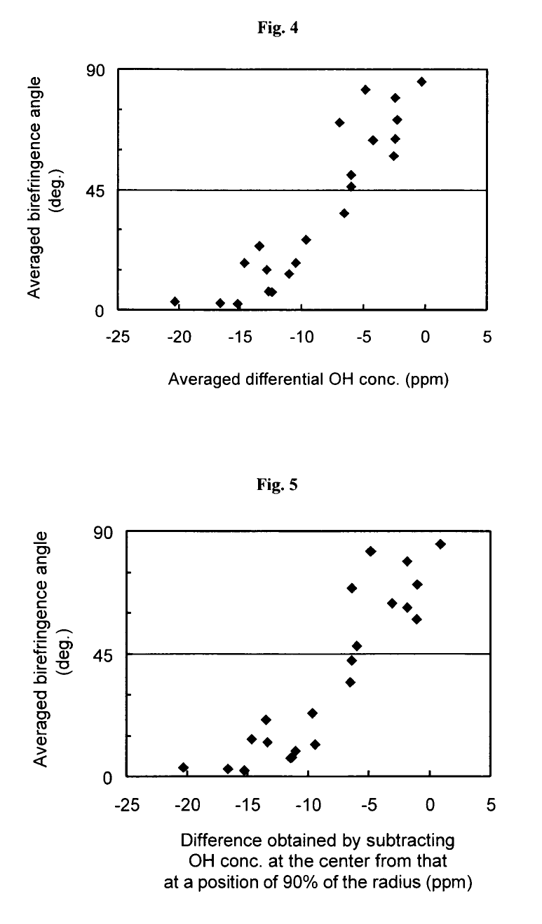

FIG. 4 shows the relationship between the average OH group concentration gradient (in the invention, this term may be referred to as “averaged differential OH concentration”) and the directions of fast axes which is defined in the first aspect of the invention.

The abscissa in FIG. 4 indicates the average OH group concentration gradient. The average OH group concentration gradient is calculated specifically by the following method. For the purpose of noise reduction from found values, the concentrations determined at three points in total, i.e., a position corresponding to a given radius and adjacent points before and after that, are converted to a moving average. Subsequently, from the found values for adjacent two points in the OH group concentration distribution from which noises have been removed, the concentration gradient at the midpoint between them is calculated. Finally, such concentration gradients at midpoints are averaged over the whole evaluation region. Furthermore, the unbiased standard deviation of gradient of the OH group concentration (in the invention, this term may be referred to as “unbiased standard deviation of a differential OH group concentration”) in the first and second aspects of the invention is a standard deviation obtained by calculating, after the noise reduction, the gradients of found concentration values for the measurements points in the whole evaluation region and calculating the standard deviation of these gradient values which are regarded as samples extracted from a population. Incidentally, the average OH group concentration gradient and unbiased standard deviation of the gradient in the invention are given in terms of values obtained through the normalization of the radius corresponding to the denominator of gradient with the radius of the synthetic quartz glass. Because of this, the units of the average and unbiased standard deviation calculated do not include the dimension of length.

The ordinate in FIG. 4 indicates the value obtained by averaging the directions of fast axes at birefringence evaluation points over the whole evaluation region, i.e., the whole region located inward from the peripheral edge of the synthetic quartz glass at a distance of 10 mm therefrom. In the data shown in FIG. 4, the precision annealing conditions are the same and the unbiased standard deviation σ of gradient determined with the formula (1) is 10 ppm or lower.

It can be seen from FIG. 4 that when the average OH group concentration gradient is low, then the average angle of fast axes is small, i.e., the fast axes are in radial directions. On the other hand, it can also be seen from FIG. 4 that as the average gradient increases toward the positive-value side, the average angle of fast axes approaches 90°, i.e., the fast axes become in tangent directions.

Specifically, when the gradient is lower than −10 ppm, the average angle of fast axes is smaller than 45°. When the gradient is −10 ppm or higher, the average angle of fast axes is 45° or larger. Furthermore, when the gradient is lower than −15 ppm, the average angle of fast axes is smaller than 30°. When the gradient is −5 ppm or higher, the average angle of fast axes is 55° or larger.

The unbiased standard deviation σ of gradient determined with the formula (1) is preferably 10 ppm or lower, more preferably 7 ppm or lower, especially preferably ppm or lower. In case where the unbiased standard deviation σ of gradient determined with the formula (1) exceeds 10 ppm, there is a high possibility that this glass locally includes areas where the OH group concentration gradient is far outside a desired range, specifically, the range of −8 ppm to +60 ppm, because of the increased fluctuations in OH group concentration distribution gradient. In this case, troubles arise. For example, there is a possibility that fast axes having a desired angle direction cannot be obtained in part of the glass material. Because of this, it is impossible to employ the technique in which the effect of birefringent properties of optical elements constituting the same optical system is countervailed by combining the fast-axis directions of these optical elements to thereby reduce the accumulated birefringence.

By regulating the average OH group concentration gradient in a synthetic quartz glass based on the relationship between the OH group concentration gradient and the directions of fast axes such as that shown in FIG. 4, the directions of the fast axes can be regulated.

FIG. 5 shows the relationship between the directions of fast axes and the difference obtained by subtracting the OH group concentration at the center of a synthetic quartz glass from the OH group concentration in a position of 90% of the radius from the center of the synthetic quartz glass.

The abscissa in FIG. 5 indicates the difference obtained by subtracting the OH group concentration at the center of a synthetic quartz glass from the OH group concentration at a position of 90% of the radius from the center of the synthetic quartz glass, in a plane perpendicular to the optical axis of the synthetic quartz glass.

The ordinate in FIG. 5 indicates the value obtained by averaging the directions of fast axes at all birefringence evaluation points. In the data shown in FIG. 5, the precision annealing conditions are the same and the unbiased standard deviation σ of gradient determined with the formula (2) is 10 ppm or lower.

It can be seen from FIG. 5 that when the difference obtained by subtracting the OH group concentration at the center of a synthetic quartz glass from the OH group concentration at a position of 90% of the radius from the center of the synthetic quartz glass is small, then the average angle of fast axes is small, i.e., the fast axes are in radial directions. On the other hand, it can also be seen from FIG. 5 that as the difference increases toward the positive-value side, the average angle of fast axes approaches 90°, i.e., the fast axes become in tangent directions.

Specifically, when the difference is smaller than −8 ppm, the average angle of fast axes is smaller than 45°. When the difference is −8 ppm or larger, the average angle of fast axes is 45° or larger. Furthermore, when the difference is smaller than about −10 ppm, the average angle of fast axes is smaller than 30°. When the difference is about −3 ppm or larger, the average angle of fast axes is 55° or larger.

The unbiased standard deviation σ of gradient determined with the formula (2) is preferably 10 ppm or lower, more preferably 7 ppm or lower, especially preferably 5 ppm or lower. In case where the unbiased standard deviation σ of gradient determined with the formula (2) exceeds 10 ppm, there is a high possibility that this glass locally includes areas where the OH group concentration gradient is far outside a desired range, specifically, the range of −8 ppm to +60 ppm, because of the increased fluctuations in OH group concentration distribution gradient. In this case, troubles arise. For example, there is a possibility that fast axes having a desired angle direction cannot be obtained in part of the glass material. Because of this, it is impossible to employ the technique in which the effect of birefringent properties of optical elements constituting the same optical system is countervailed by combining the fast-axis directions of these optical elements to thereby reduce the accumulated birefringence.

The directions of fast axes can be regulated also by regulating the average OH group concentration gradient in a synthetic quartz glass based on the relationship shown in FIG. 5, i.e., the relationship between the directions of fast axes and the difference obtained by subtracting the OH group concentration at the center of a synthetic quartz glass from the OH group concentration at a position of 90% of the radius from the center of the synthetic quartz glass.

The method of regulating the directions of fast axes by regulating the average OH group concentration gradient or the difference in OH group concentration has the following advantages. Hitherto, changing the conditions of precision annealing has been the only technique used for regulating birefringence or the directions of fast axes. However, in this method in which precision annealing only is used for the regulation, it is difficult to independently regulate both of birefringence, which represents the absolute value of birefringent properties, and fast axes, which indicate the direction of birefringent properties. For example, use of changed precision annealing conditions so as to obtain desired fast axes has frequently resulted in changes in birefringence to undesirable values. It has hence been impossible to regulate both of birefringence and fast axes to desired values and, as a result, these two properties have been unavoidably regulated to respective compromising values. Furthermore, the proper range of precision annealing conditions for obtaining the compromising values is narrow, and it has been necessary to highly control the conditions. This has made it difficult to improve product yield.

In contrast, in the process according to the invention, fast axes can be regulated by regulating the average OH group concentration gradient or the difference in OH group concentration. Because of this, a birefringence and fast axes, such as ones unable to be obtained by the regulation with precision annealing conditions only which has been used hitherto, can be obtained without compromise. In addition, limitations on the proper range of precision annealing conditions also are mitigated to contribute to an improvement in yield.

With respect to the physical causal relation of the average gradient of the concentration of OH groups contained in a synthetic quartz glass or the difference in the concentration thereof to the directions of fast axes, the following are thought.

When the average OH group concentration gradient or the difference in the concentration is zero, i.e., the OH group concentration distribution is nearly even, or when the average gradient or the difference is a positive value, i.e., the glass has a distribution in which the OH group concentration gradually increases from about the center axis toward a peripheral part, then the residual stress in this synthetic quartz glass is thought to be dominated by the viscous relaxation action during cooling in precision annealing. Incidentally, this viscous relaxation action is a physical action attributable to the self-diffusion of silicon atoms and oxygen atoms and differs from the structural relaxation of OH groups which will be described below. The former relaxation is also called major relaxation and the latter is also called secondary relaxation. The degree of the permanent strain resulting from this viscosity relaxation positively depends on the temperature distribution and viscosity coefficient of the synthetic quartz glass at about the glass transition temperature. Furthermore, in the case of synthetic quartz glasses, OH group concentration influences on the viscosity coefficient. Usually, a synthetic quartz glass is cooled from the outside and the temperature distribution in this cooling tends to have a larger gradient toward the periphery. In the case of a synthetic quartz glass having an OH group concentration distribution such as that shown above, this glass has a viscosity coefficient distribution in which the viscosity coefficient is almost even or becomes smaller toward the periphery. Consequently, the permanent strain on the tensile side in this case becomes larger toward the periphery. The tensile permanent strain induces a compressive stress after the synthetic quartz glass has been cooled to room temperature and come into the state of having an even temperature distribution. Because of this, the fast axes in this case are in the directions of tangents to concentric circles.

On the other hand, when the average OH group concentration gradient or the difference in the concentration is sufficiently large on the negative side, i.e., when the OH group concentration is high about the center axis and decreases considerably toward the periphery, then the permanent strain in this synthetic quartz glass is influenced by the viscous relaxation action (major relaxation action) described above. However, the permanent strain is dominated more by the structural relaxation (secondary relaxation action) of OH groups than by that influence. In the case where 3-membered or 4-membered ring structures coexist with OH groups in a synthetic quartz glass, the OH groups cause these structures to undergo ring opening to thereby attain a reduction in Si—O—Si bond energy. It is thought that this ring opening causes a local density decrease in the synthetic quartz glass. Based on this assumption, a synthetic quartz glass having a high OH group concentration about the center axis thereof is thought to have a lower density about the center axis of the synthetic quartz glass than around the periphery thereof. Due to this density difference, compressive stress components generate about the center axis and tensile stress components generate about the periphery, respectively. In the case where the stress components attributable to this secondary relaxation are larger than the stress components attributable to the major relaxation described above, the fast axes are in radial directions.

Consequently, for producing a synthetic quartz glass having fast axes distributed radially, it is preferred to conduct the dehydration for a relatively short time period to thereby regulate the average OH group concentration gradient from the center toward the periphery to below −8 ppm or regulate the difference obtained by subtracting the OH group concentration at the center from the OH group concentration in a position of 90% of the radius from the center to below −8 ppm. More preferably, the average OH group concentration gradient from the center toward the periphery is regulated to below −10 ppm, or the difference in OH group concentration between the center and the peripheral part is regulated to below −10 ppm. This regulation, in which the average OH group concentration gradient from the center toward the periphery is regulated to below −8 ppm or the difference in OH group concentration between the center and the peripheral part is regulated to below −8 ppm, is accomplished by dehydrating the porous glass body by holding it at a temperature of 1,100 to 1,350° C. for a period of not less than 10 hours and less than 50 hours at a reduced pressure or in an atmosphere having a low partial water vapor pressure.

The temperature range in the dehydration step is preferably 1,100 to 1,350° C., more preferably 1,200 to 1,300° C. In case where the temperature is lower than 1,100° C., the rate of OH group desorption is low because the energy necessary for cutting OH group bonds is not sufficiently obtained. On the other hand, in case where the temperature is higher than 1,350° C., the following troubles arise although a higher rate of OH group desorption is obtained. Namely, sintering of the porous quartz glass body proceeds and, hence, OH groups are apt to remain excessively in parts where vitrification has proceeded quickly. On the other hand, in parts where vitrification has proceeded relatively slowly, dehydration proceeds excessively and oxygen-deficient defects are apt to generate. Thus, too high temperatures are undesirable because OH group desorption is apt to be locally excessive or insufficient and oxygen-deficient defects are apt to generate.

With respect to the atmosphere for the dehydration step, either an atmosphere having a low partial water vapor pressure or a reduced-pressure atmosphere may be used. In the case of conducting the dehydration step in an atmosphere having a low partial water vapor pressure using an inert gas or another gas, it is preferable to sufficiently discharge the atmosphere gas prior to a vitrification step to be conducted successively to the dehydration step, in order to prevent the gas from being incorporated into the glass during the vitrification step. Alternatively, it is necessary that a gas which highly permeates the glass, such as, e.g., helium, should be used as the atmosphere gas. In the case where the dehydration step is conducted at a reduced pressure, the degree of vacuum is preferably 10 Pa or lower, more preferably 1 Pa or lower.

On the other hand, for producing a synthetic quartz glass having fast axes distributed in the directions of tangents to concentric circles, it is preferred to conduct the dehydration for a prolonged time period to thereby regulate the average OH group concentration gradient from the center toward the periphery to −8 ppm or larger or regulate the difference obtained by subtracting the OH group concentration at the center from the OH group concentration in a position of 90% of the radius from the center to −8 ppm or larger. More preferably, the average OH group concentration gradient from the center toward the periphery is regulated to −5 ppm or larger, or the difference in OH group concentration between the center and the peripheral part is regulated to −5 ppm or larger.

This regulation, in which the average OH group concentration gradient from the center toward the periphery is regulated to −8 ppm or larger or the difference in OH group concentration between the center and the peripheral part is regulated to −8 ppm or larger, is accomplished by dehydrating the porous glass body by holding it at a temperature of 1,100 to 1,350° C. for a period of 60 hours or longer at a reduced pressure or in an atmosphere having a low partial water vapor pressure.

The time period of holding the porous glass body at a temperature in that range in the dehydration step is preferably 60 hours or longer, more preferably from 65 hours to 90 hours.

The bulk density of the porous glass body in the dehydration step is preferably 0.10-0.90 g/cm³, more preferably 0.20-0.50 g/cm³.

The preferred temperature range and atmosphere are the same as shown above for the same reasons.

Subsequently, the porous quartz glass body dehydrated is heated to a vitrification temperature for transparent-glass formation and converted to a transparent quartz glass.

In order to mold the resultant quartz glass body into a desired shape, a mold is used to thermally mold the glass body at a temperature not lower than the softening point thereof. The temperature for this molding is preferably selected from the range of 1,650 to 1,800° C. Temperatures lower than 1,650° C. are undesirable because the quartz glass at such temperatures has a high viscosity and hence undergoes substantially no self-weight deformation and because the growth of cristobalite, which is a crystal phase of SiO₂, occurs to cause the so-called devitrification. Temperatures exceeding 1,800° C. are undesirable because SiO₂ sublimation is not negligible and impurity diffusion from the molding atmosphere is apt to occur to cause contamination.

The direction in which the self-weight deformation of the quartz glass body is to be caused is not particularly limited. It is, however, preferred to mold the quartz glass body by compressing it in the same direction as that of the growth of the porous quartz glass body. This is because properties of the synthetic quartz glass obtained through this molding are distributed symmetrically with respect to the axis.

The quartz glass body obtained is heated in an electric furnace to a temperature not lower than annealing points, i.e., to about 1,000 to 1,400° C., and held for 10 to 30 hours. Thereafter, the glass body is subjected to precision annealing.

The degree of vacuum in the precision annealing step is preferably 10 Pa or lower, especially preferably 1 Pa or lower. By regulating the degree of vacuum to 10 Pa or lower, main heat dissipation from the quartz glass body can be made to occur not by convection but by radiation. Thus, the quartz glass body can be evenly cooled.

Heating temperatures lower than 1,000° C. are undesirable because the effect of reducing birefringent properties is low. On the other hand, temperatures exceeding 1,400° C. are undesirable because fine cristobalite crystals are apt to grow on impurities as nuclei to cause devitrification.

The rate of cooling in the precision annealing is preferably 5° C./hr or lower, more preferably 1° C./hr or lower. In case where the rate of cooling exceeds 5° C./hr, a large temperature difference is apt to arise in the synthetic quartz glass and the thermal stress attributable to this temperature difference causes a permanent strain unsuitable for the realization of desired birefringent properties. Such high cooling rates are unsuitable for the purpose of producing a synthetic quartz glass having a low birefringence.

The quartz glass body which has undergone the precision annealing is subjected to grinding, cutting, etc. to obtain an optical element for an exposure apparatus. In optical elements having a large diameter, the influence of birefringent properties which impairs imaging characteristics is not negligible. In view of this, optical elements for which the invention is suitable are optical elements preferably having a diameter of 100 mm or larger, more preferably 200 mm or larger, even more preferably 400 mm or larger.

OH groups are a precursor for a defect having an absorption band including 260 nm, and the presence of a large amount of OH groups may yield this defect. For inhibiting a transmittance from decreasing during laser light irradiation, it is preferable to regulate the concentration of OH groups to 60 ppm or lower, more preferably 30 ppm or lower, even more preferably 20 ppm or lower.

The birefringence and the directions of birefringent fast axes of the optical element obtained are determined, for example, by the optical heterodyne method employing an He—Ne laser with a wavelength of 633 nm as a light source. In the case of as a lens for an optical element in an exposure apparatus, the value of birefringence thereof is preferably 1 nm/cm or less, more preferably 0.5 nm/cm or less, even more preferably 0.2 nm/cm or less.

The distance between birefringence evaluation points preferably is 10 mm or smaller and 1 mm or larger. Distances larger than 10 mm are undesirable because there is a possibility that the birefringence of the optical element and the distribution of fast axes therein cannot be precisely grasped. Distances smaller than 1 mm are undesirable from the standpoint of productivity because the measurement requires much time.

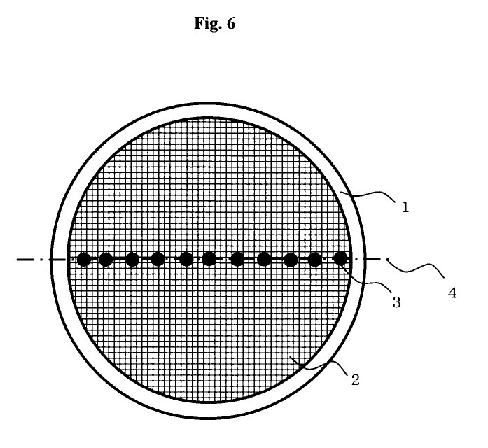

An explanation is given below on measurement points for determining the directions of birefringent fast axes. When the directions of birefringent fast axes are determined, a measurement is made on a measurement plane perpendicular to the optical axis of the synthetic quartz glass. The measurement region is either the region surrounded by a curve apart from the center of the measurement plane at a distance corresponding to 90% of the distance between the center of the measurement plane and each point on the periphery of the measurement plane or the region surrounded by a curve located inward from the periphery of the measurement plane at a distance of 10 mm therefrom. The measurement points are points on a straight line which passes through the center and extends within the measurement region. The measurement region is circular, and the measurement points are points on an arbitrary diameter. FIG. 6 shows examples of: a measurement region 2 for determining the directions of fast axes in a measurement plane 1; measurement points 3 for determining the directions of fast axes; and a line 4 passing through the center of the measurement plane 1.

### EXAMPLES

Specific embodiments of the invention will be given below. Examples 2 and 4 are Examples according to the invention, while Examples 1 and 3 are Reference Examples. The invention should not be construed as being limited to the following Examples.

### Example 1

SiCl₄ was introduced into an oxyhydrogen flame and the fine quartz glass particles synthesized in the flame were deposited and grown on a substrate to form a porous quartz glass body.

The porous quartz glass body obtained was held in a high-purity helium atmosphere having atmospheric pressure at a temperature of 1,150° C. for 30 hours to dehydrate the glass body.

After the dehydration step, the porous quartz glass body was held at a temperature of 1,500° C. and a reduced pressure of less than or equal to 10 Pa for 3 hours to vitrify it.

The synthetic quartz glass body obtained was heated at 1,700° C. in an inert atmosphere and molded into a cylindrical shape to produce a synthetic quartz glass molding.

The synthetic quartz glass molding was sliced and polished to obtain a synthetic quartz glass body having a diameter of 360 mm and a thickness of 60 mm.

Subsequently, the synthetic quartz glass body obtained was heated to 1,250° C. and held for 20 hours at a reduced pressure, and was then cooled at 2° C./hr to conduct precision annealing. Thus, a measurement sample was obtained.

The measurement sample was examined for the distribution of OH group concentration and the distribution of birefringent properties. That inner region in the synthetic quartz glass which excluded the peripheral area extending inward from the peripheral edge to a distance of 10 mm was examined for OH group concentration with a Fourier transform infrared spectrophotometer at an interval of 10 mm, and was further evaluated for birefringent properties at an interval of 10 mm by the optical heterodyne method employing an He—Ne laser with a wavelength of 633 nm as a light source. The average of fast-axis angles (θ_{xy}) was determined using equations (A) and (B). As a result, the average OH group concentration gradient and the average value of θ_{xy} were found to be −10 ppm and 18°, respectively.

### Example 2

A synthetic quartz glass was produced in the same manner as in Example 1, except for the treatment time in the dehydration step and the mold. The treatment time in the dehydration step was changed to 80 hours, and the measurement sample size was changed to have a diameter of 220 mm and a thickness of 60 mm. The synthetic quartz glass thus obtained was evaluated in the same manner as in Example 1. As a result, the average OH group concentration gradient and the average fast-axis angle were found to be −2 ppm and 71°, respectively.

### Example 3

A synthetic quartz glass was produced in the same manner as in Example 1, except for the treatment temperature in the dehydration step and the mold. The treatment conditions for the dehydration step included 1,230° C. and 30-hour holding, and the sample size was changed to have a diameter of 270 mm and a thickness of 56 mm. The synthetic quartz glass thus obtained was examined in the following manner. The region ranging from the center of the synthetic quartz glass to 90% of the radius thereof was examined for OH group concentration with a Fourier transform infrared spectrophotometer at an interval of 10 mm, and was further evaluated for birefringent properties at an interval of 10 mm by the optical heterodyne method employing an He—Ne laser with a wavelength of 633 nm as a light source. The average of fast-axis angles (θ_{xy}) was determined using equations (A) and (B). As a result, the average OH group concentration gradient and the average fast-axis angle were found to be −13 ppm and 21°, respectively.

### Example 4

A synthetic quartz glass was produced in the same manner as in Example 3, except for the treatment temperature in the dehydration step and the mold. The treatment conditions for the dehydration step included 1,230° C. and 65-hour holding, and the sample size was changed to have a diameter of 220 mm and a thickness of 60 mm. The synthetic quartz glass thus obtained was evaluated in the same manner as in Example 3. As a result, the average OH group concentration gradient and the average fast-axis angle were found to be −2 ppm and 79°, respectively.

The results obtained in Examples 1 to 4 are summarized in Table 1.

TABLE 1

| | | | Average | | |
|---|---|---|---|---|---|
| | | Dehy- | OH group | Average | Unbiased |
| | Dehydration | dration | concentration | value of | standard |
| | temperature | time | gradient | θ_{xy} | deviation |
| | (° C.) | (hour) | (ppm) | (°) | (ppm) |
| Example 1 | 1150 | 30 | −10 | 18 | 5.1 |
| Example 2 | 1150 | 80 | −2 | 71 | 4.8 |
| Example 3 | 1230 | 30 | −13 | 21 | 9.2 |
| Example 4 | 1230 | 65 | −2 | 79 | 1.0 |

While the present invention has been described in detail and with reference to specific embodiments thereof, it will be apparent to one skilled in the art that various changes and modifications can be made therein without departing from the spirit and scope thereof.

The present application is based on Japanese Patent Application No. 2006-020920 filed on Jan. 30, 2006, and the contents thereof are incorporated herein by reference.

### INDUSTRIAL APPLICABILITY

The synthetic quartz glass of the invention can be used as a material for optical parts such as lenses, prisms, photomasks, and window materials for optical apparatus employing an ArF excimer laser (wavelength, 193 nm), KrF excimer laser (wavelength, 248 nm), or the like as a light source.

1. A synthetic quartz glass having a diameter of 100 mm or more for using in an optical apparatus comprising a light source emitting a light having a wavelength of 250 nm or less,
the synthetic quartz glass having, in a region located inward from the periphery thereof by 10 mm or more in a plane perpendicular to the optical axis of the synthetic quartz glass:
a birefringence of 0.5 nm or less per thickness of 1 cm with respect to a light having a wavelength of 193 nm;
an OH group concentration of 60 ppm or less;
an averaged differential OH group concentration from the center of the synthetic quartz glass toward a peripheral direction thereof, normalized with respect to the radius of the synthetic quartz glass, of −8 to +60 ppm; and
an unbiased standard deviation σ of a differential OH group concentration from the center of the synthetic quartz glass toward a peripheral direction thereof, normalized with respect to the radius of the synthetic quartz glass, of 10 ppm or less,
the unbiased standard deviation σ being determined with the following formula (1):
$$σ = \sqrt{\frac{{\sum }_{i = 1}^{n} {( {X}_{i} - \overline{X} )}^{2}}{n - 1}} \\ providing ; \\ {X}_{i} = \frac{Δ {\overline{n}}_{OH i}}{Δ {r}_{i}^{*}} = \frac{{\overline{n}}_{OH i} - {\overline{n}}_{OH i + 1}}{ {r}_{i}^{*} - {r}_{i + 1}^{*}} \qquad ( 1 )$$
: differential OH group concentration at measurement point i normalized with respect to the radius R of the synthetic quartz glass;
$${\overline{n}}_{OH i} = \frac{{n}_{OH i - 1} + {n}_{OH i} + {n}_{OH i + 1}}{3}$$
: OH group concentration at measurement point i in terms of moving average for three points including the two points before and after the measurement point i;
$${r}_{i}^{*} = \frac{{r}_{i}}{R}$$
: radius at measurement point i normarized with respect to the radius R of the synthetic quartz glass;
X̅
average of OH group concentrations Xi in the whole evaluation region; and
n
: number of measurement points in the evaluation region (integer of 2 or more).

2. A synthetic quartz glass having a diameter of 100 mm or more for using in an optical apparatus comprising a light source emitting a light having a wavelength of 250 nm or less,
the synthetic quartz glass having, in a region extending from the center of the synthetic quartz glass to 90% of the radius thereof in a plane perpendicular to the optical axis of the synthetic quartz glass:
a birefringence of 0.5 nm or less per thickness of 1 cm with respect to a light having a wavelength of 193 nm;
an OH group concentration of 100 ppm or less;
the difference, obtained by subtracting: the OH group concentration at the center of the synthetic quartz glass; from the OH group concentration at the position of 90% of the radius from the center of the synthetic quartz glass, of −8 to +60 ppm; and
an unbiased standard deviation σ of a differential OH group concentration from the center of the synthetic quartz glass toward a peripheral direction thereof, normalized with respect to the radius of the synthetic quartz glass, of 10 ppm or less,
the unbiased standard deviation σ being determined with the following formula (2):
$$σ = \sqrt{\frac{{\sum }_{i = 1}^{n} {( {X}_{i} - \overline{X} )}^{2}}{n - 1}} \\ providing ; \\ {X}_{i} = \frac{Δ {\overline{n}}_{OH i}}{Δ {r}_{i}^{*}} = \frac{{\overline{n}}_{OH i} - {\overline{n}}_{OH i + 1}}{ {r}_{i}^{*} - {r}_{i + 1}^{*}} \qquad ( 2 )$$
: differential OH group concentration at measurement point i normalized with respect to the radius R of the synthetic quartz glass;
$${\overline{n}}_{OH i} = \frac{{n}_{OH i - 1} + {n}_{OH i} + {n}_{OH i + 1}}{3}$$
: OH group concentration at measurement point i in terms of moving average for three points including the two points before and after the measurement point i;
$${r}_{i}^{*} = \frac{{r}_{i}}{R}$$
: radius at measurement point i normarized with respect to the radius R of the synthetic quartz glass;
X̅
average of OH group concentrations Xi in the whole evaluation region; and
n
number of measurement points in the evaluation region (integer of 2 or more).

3. A process for producing a synthetic quartz glass, comprising
dehydrating a porous glass body having a bulk density of 0.10 to 0.90 g/cm³ at a temperature of 1100 to 1350° C. for 60 hours or more under at least one of: a reduced pressure; and an atmosphere having a low partial pressure of water vapor.
